(19) United States
(12) Patent Application Publication
(10) Pub. No.: US 2026/0367370 A1
(43) Pub. Date: Nov. 19, 2026

(54) MEDIUM-SHORT FOCAL LENGTH LENS WITH AN ULTRA-LARGE APERTURE FOR M43 FORMAT

(71) Applicant: GUANGDONG SIRUI OPTICAL CO., LTD, Zhongshan (CN)

(72) Inventors: Jie Li, Zhongshan (CN); Guoliang Zhu, Zhongshan (CN); Bengang Shi, Zhongshan (CN)

(73) Assignee: GUANGDONG SIRUI OPTICAL CO., LTD, Zhongshan (CN)

(21) Appl. No.: 19/253,886

(22) Filed: Jun. 29, 2025

(30) Foreign Application Priority Data
May 15, 2025 (CN) 202510633254.5
May 15, 2025 (CN) 202520968010.8

(51) Int. Cl. G02B 15/14; G02B 13/00

(52) U.S. Cl. CPC G02B 15/144113; G02B 13/0045

(57) ABSTRACT

An M43 format ultra-large aperture medium-short focal length lens comprise four lens groups arranged from the object side to the image side along the optical axis: the first, second, third, and fourth lens groups. The focal lengths of these lens groups must satisfy the following conditions: 3<f(G1)/F<5; −4<f(G3)/F<−2; 0.5<f(G2)/f(G4)<0.9; 0.4<f(G4)/f(G1−G3)<1.5. The focusing mechanism of this ultra-large aperture medium-short focal length lens is composed of a single lens, reducing the weight of the focusing group and the load on the motor, thus facilitating quick focusing for both the lens and imaging equipment, meeting the requirements for automatic focusing design. This lens corrects various aberrations across different wavelength bands, ensuring sufficient resolution in both the center and peripheral fields of view.

### TECHNICAL FIELD

Aspects of the invention generally relate to the field of optical lens technology. In particular, embodiments of the invention relate to an M43 frame aperture with an ultra-large aperture and short focal length.

### BACKGROUND

In recent years, the multi-function shooting capabilities of compact camera groups, including DSLR cameras, mirrorless cameras, and compact cameras, have been increasingly replaced by smartphones. However, for photographic enthusiasts or professionals with higher expectations, mirrorless cameras and lenses can better leverage the performance of optical equipment, meeting the needs for comprehensive, colorful, background blur, and soft bokeh effects, thus providing a more desirable photography experience. Mirrorless cameras are favored by professional studios and photography enthusiasts due to their small size, light weight, portability, larger image sensors, and wider apertures. Cameras like those with a Micro Four Thirds (“M43”) format are prime examples of this trend.

Existing ultra-large aperture medium-short focal length lenses face issues such as various aberrations that are difficult to correct desirable, low resolution, and the lack of automatic focusing capabilities. Additionally, most traditional ultra-large aperture medium-short focal length lenses do not have automatic focusing functions. The problem lies in the heavy internal focusing components, which require a motor with significant load to move them for rapid autofocus, making it challenging to meet the fast focusing design requirements of ultra-large aperture lenses. Currently, no autofocus lenses with an F-stop or F-number smaller than F #1.0 (where F-number is the focal length divided by the aperture diameter) have been released.

### SUMMARY

Embodiments of the invention address shortcomings of existing technologies and market demands by providing an M43 format ultra-large aperture medium-short focal length lens. In one aspect, embodiments of the invention provide a lens that is compact and lightweight, with its internal focusing mechanism comprising a single lens. In addition, further embodiments of the invention feature fast focusing speed and superior imaging performance, making it suitable for M43 format optical imaging systems.

In some embodiments, technical solutions of embodiments of the present invention include at least the following:

A super wide or ultra-large aperture medium-short focal length lens of a M43 format includes a first lens group, a second lens group, a third lens group and a fourth lens group arranged sequentially from the object side to the image side along the optical axis; the focal length of all lens groups satisfies the following conditions:

3<f(G1)/F<5;

−4<f(G3)/F<−2;

0.5<f(G2)/f(G4)<0.9; and

0.4<f(G4)/f(G1−G3)<1.5;

Where f(G1) represents the focal length of the first lens group, f(G2) represents the focal length of the second lens group, f(G3) represents the focal length of the third lens group, f(G4) represents the focal length of the fourth lens group, and f(G1-G3) represents the combined focal length of the first, second, and third lens groups; F represents the combined focal length of all lens groups.

In one embodiment, the third lens group comprises only one lens; and the third lens group may be moving along the optical axis to achieve focusing.

Further, the first lens group comprises a first lens, a second lens, a third lens, a fourth lens, a fifth lens, a sixth lens and a seventh lens arranged sequentially from the object side to the image side along the optical axis.

In some embodiments, the first lens may be a positive refractive power lens with a convex surface facing the object side.

In some embodiments, the second lens may be a negative refractive power lens with a concave surface facing the image plane.

In some embodiments, the third lens may be a double concave lens.

In some embodiments, the fourth lens may be a double convex lens.

In some embodiments, the fifth lens may be a double convex lens.

In some embodiments, the sixth lens may be a positive refractive power lens with a convex surface facing the object side.

In some embodiments, the seventh lens may be a negative light focal power lens with a concave surface facing the image side.

Further, the second lens group may include an eighth lens, a ninth lens and a tenth lens arranged sequentially from the object side to the image side along the optical axis.

In some embodiments, the eighth lens may be a double concave lens.

In some embodiments, the ninth lens may be a positive refractive power lens with a convex surface facing the image side.

In some embodiments, the tenth lens may be a double convex lens.

Further, the third lens group may include an eleventh lens, which may be a crescent-shaped lens with a convex surface facing the object side.

Further, the fourth lens group may include the twelfth lens, the thirteenth lens and the fourteenth lens arranged sequentially from the object side to the image side along the optical axis.

In some embodiments, the twelfth lens may be a double convex lens.

In some embodiments, the thirteenth lens may be a double convex lens.

In some embodiments, the fourteenth lens may be a double concave lens.

Further, the distance between the twelfth lens and the first lens satisfies the following condition:

0.15<S3/S<0.4.

Among them, S3 may be the distance from the intersection point of the optical axis of the twelfth lens object side to the image plane when the infinity focal point is achieved, and S is the distance from the intersection point of the first lens object side and the optical axis to the image plane when the infinity focal point is achieved.

Further, the first lens, the sixth lens and the thirteenth lens may be all optical lenses with a refractive index higher than 1.9.

Further, the aperture of the M43 frame super wide or ultra-large aperture medium short focal length lens may be 0.9-1.2.

Furthermore, the focal length range of the M43 frame's ultra-large aperture medium-short focus lens may be 15 mm to 35 mm.

Further, the fifth lens, the tenth lens and the eleventh lens may be all aspherical lenses.

Embodiments of the invention attempt to offer the following advantages. For example, in the M43 format, the ultra-large or super wide aperture medium-short focal length lens may feature a third lens group that includes only one lens as the focusing element. This design may reduce the weight of the focusing group and the load on the motor, facilitating quick focusing for both the ultra-large aperture medium-short focal length lens and imaging devices, thus meeting the design requirements for autofocus lenses. Additionally, this ultra-large aperture medium-short focal length lens may correct various aberrations across different wavelength bands, ensuring sufficient resolution in both the center and peripheral fields of view. In another example, aspects of the invention may boast a simple structure, compact size, and large aperture, enabling high-resolution imaging from infinity to close distances. Furthermore, by reasonably distributing the optical power, embodiments of the invention may ensure high image brightness while maintaining an ultra-large aperture of 0.95.

### BRIEF DESCRIPTION OF THE DRAWINGS

To better illustrate the specific embodiments of this invention or the technical solutions in existing technologies, the following is a brief introduction to the drawings referred to in the description. It is to be understood that the drawings described below represent some embodiments of this invention. Ordinary skilled in the art may also derive additional drawings from these without undue experimentation.

FIG. 1 is a sectional structural diagram of a Micro Four Thirds (M43) format ultra-large aperture medium-short focal length lens according to one embodiment of the present invention.

FIG. 2 shows a spherical aberration of a M43 frame super large aperture medium-short focal length lens at infinity when the object distance is infinite in Example 1 according to one embodiment of the present invention.

FIG. 3 shows a field distortion of a M43 frame super wide aperture medium-short focal length lens at infinity when the object distance is infinite according to one embodiment of the present invention.

FIG. 4 is a sectional structure diagram of a M43 format ultra-large aperture medium-short focal length lens in another embodiment of the present invention.

FIG. 5 is a spherical aberration of a M43 frame super large aperture medium-short focal length lens when the object distance is infinite in Example 2 according to one embodiment of the present invention.

FIG. 6 shows a field distortion of a M43 frame super wide aperture medium-short focal length lens at infinity when the object distance is infinite in Example 2 according to one embodiment of the present invention.

### REFERENCE NUMBER USED IN THE FIGURES

G1: a first lens group; G2: a second lens group; G3: a third lens group; G4: a fourth lens group; L1: a first lens; L2: a second lens; L3: a third lens; L4: a fourth lens; L5: a fifth lens; L6: a sixth lens; L7: a seventh lens; L8: an eighth lens; L9: a ninth lens; L10: a tenth lens; L11: an eleventh lens; L12: a twelfth lens; L13: a thirteenth lens; L14: a fourteenth lens.

### DETAILED DESCRIPTION

The following will provide a clear and complete description of embodiments of the invention, in conjunction with the accompanying drawings. Clearly, the described embodiments may be part of the invention, not all of them. Based on these embodiments, all other embodiments that may be obtained by ordinary skilled persons in the field without making inventive efforts fall within the scope of protection of embodiments of the invention.

In the description of embodiments of the invention, it is important to note that terms such as “center,” “up,” “down,” “left,” “right,” “vertical,” “horizontal,” “inside,” and “outside” may indicate directions or positions based on the orientation shown in the drawings. These terms are used for convenience and simplification, not to suggest that the devices or components must be constructed or operated in a specific direction. Therefore, these terms should not be interpreted as limiting the invention. Additionally, terms like “first,” “second,” and “third” are used for descriptive purposes and do not imply any relative importance.

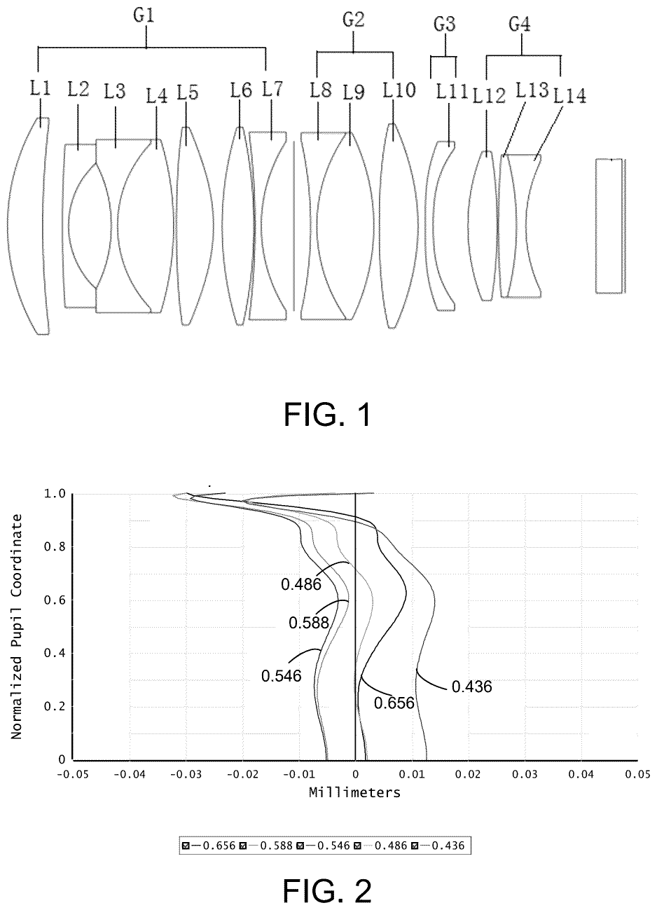

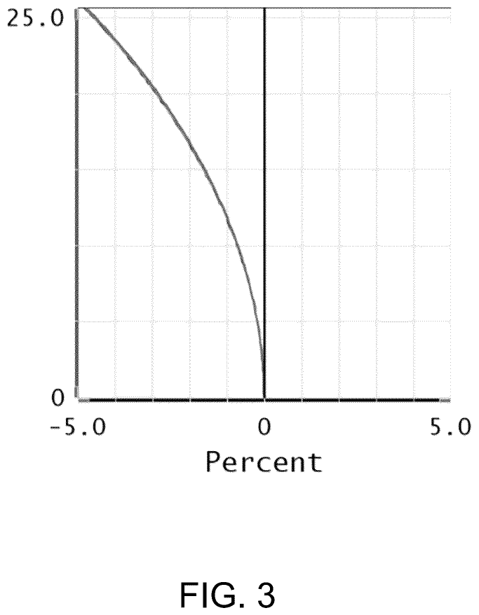

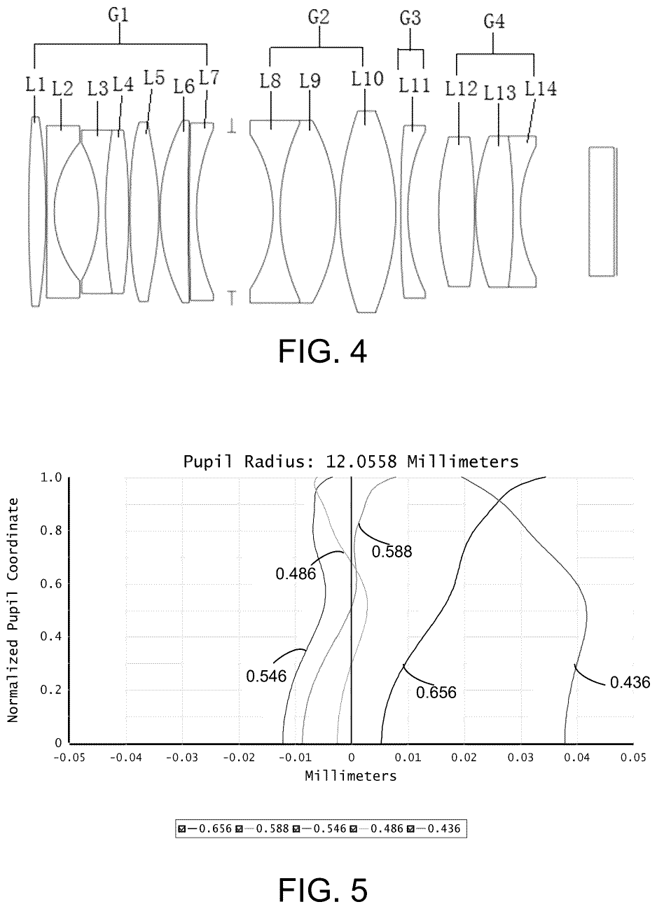

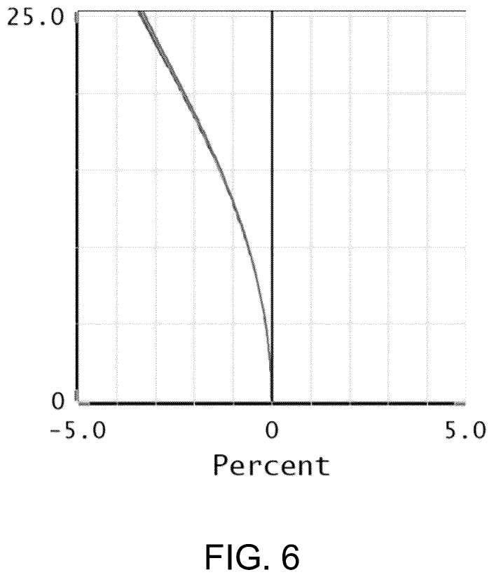

Referring now to FIGS. 1 to 6, a M43 format super wide or ultra-large aperture medium-short focal length lens may include a first lens group G1, a second lens group G2, a third lens group G3, and a fourth lens group G4 arranged sequentially from the object side to the image side along the optical axis.

In one example, the focal length of all lens groups satisfies the following conditions:

3<f(G1)/F<5;

−4<f(G3)/F<−2;

0.5<f(G2)/f(G4)<0.9; and

0.4<f(G4)/f(G1−G3)<1.5;

In one example, f(G1) represents the focal length of the first lens group G1, f(G2) represents the focal length of the second lens group G2, f(G3) represents the focal length of the third lens group G3, f(G4) represents the focal length of the fourth lens group G4, and f(G1-G3) represents the combined focal length of the first, second, and third lens groups. F represents the combined focal length of all lens groups. The third lens group G3 consists of only one lens, and it is moved along the optical axis to achieve focusing.

In some embodiments, the reference to super wide in the present disclosure may be used interchangeably as ultra-large.

In some embodiments, the M43 format ultra-large aperture medium-short focal length lens may have its third lens group comprise a single lens. In another embodiment, the third lens group may consist of a single lens. In another embodiment, the third lens group may reduce the weight of the focusing system and the load on the motor, facilitating a quick focusing for ultra-large aperture medium-short focal length lenses and imaging devices, thus meeting the design requirements for autofocus lenses. Additionally, in some embodiments, the ultra-large aperture medium-short focal length lens may correct various aberrations across different wavelength bands, ensuring sufficient resolution in both the center and peripheral fields of view. It features a simple structure, compact size, and large aperture, enabling high-resolution imaging from infinity to close distances. Furthermore, by reasonably distributing the optical power, Embodiments of the invention ensures good image brightness while maintaining an ultra-large aperture of 0.95.

It is to be noted that the M43 format, also known as Micro Four Thirds (M43), is a camera sensor specification. This standard defines the interface between lenses and camera sensors and uses an image sensor with a 17.3 mm×13.0 mm size, measuring approximately 21.6 mm diagonally. This size is exactly half the diagonal length of a 35 mm full-frame sensor, hence it is called the ‘four-three’ system, due to its 4:3 aspect ratio, which differs from the traditional 3:2 aspect ratio of 35 mm film cameras. Due to the smaller sensor, M43 lenses are typically more compact and lighter than those of DSLR cameras. An ultra-large aperture refers to a camera lens that can achieve a very large aperture opening, allowing more light to enter the camera sensor. The aperture size is usually indicated by the F-number or F-stop (f/D), where a smaller F-number indicates a larger aperture. Generally, a lens with an aperture value greater than F/2 is considered a large-aperture lens, and an ultra-large aperture lens has a maximum aperture value of F/1.2 or less. For example, a lens with an F-number of F/0.95 is considered an ultra-large aperture lens. Medium-short focal length lenses are typically neither ultra-wide-angle nor telephoto lenses. Generally, short focal length lenses refer to lenses with a focal length of 35 mm or less, such as lenses with a focal length of 14-24 mm being short focal length lenses; medium focal length lenses typically have a focal length ranging from about 50 mm to 100 mm. Therefore, the focal length range of “medium-short focal lens” in this application can be roughly understood as between 14 mm and 100 mm.

In some embodiments, the first lens group G1 may include the following lenses arranged from the object side to the image side along the optical axis: the first lens L1, the second lens L2, the third lens L3, the fourth lens L4, the fifth lens L5, the sixth lens L6, and the seventh lens L7. In one example, the first lens L1 may be a positive refractive power lens with its convex surface facing the object side. The second lens L2 may be a negative refractive power lens with its concave surface facing the image side. The third lens L3 may be a biconcave lens. The fourth lens L4 may be a biconvex lens. The fifth lens L5 may be also a biconvex lens. The sixth lens L6 may be a positive refractive power lens with its convex surface facing the object side. The seventh lens L7 may be a negative refractive power lens with its concave surface facing the image side.

In another embodiment, the second lens group G2 may include the eighth lens L8, the ninth lens L9, and the tenth lens L10, arranged sequentially from the object side to the image side along the optical axis. The eighth lens L8 may be a biconcave lens, the ninth lens L9 may be a positive refractive power lens with its convex surface facing the image side, and the tenth lens L10 may be a biconvex lens.

In yet another embodiment, the third lens group G3 may only include the eleventh lens L11, which may be a crescent lens with a convex surface facing the object side. The third lens group G3 moves along the optical axis to achieve focusing.

In some embodiments, the fourth lens group G4 may include the twelfth lens L12, the thirteenth lens L13, and the fourteenth lens L14, arranged sequentially from the object side to the image side along the optical axis. The twelfth lens L12, the thirteenth lens L13, and the fourteenth lens L14 may be, respectively, double-convex, double-convex, and double-concave lenses.

In this embodiment, the distance between the twelfth lens L12 and the first lens L1 may satisfy the following condition: 0.15<S3/S<0.4. In another embodiment, S3 may be the distance from the intersection of the optical axis of the twelfth lens L12's object side to the image plane when focusing at infinity, and S may be the distance from the intersection of the optical axis of the first lens L1's object side to the image plane when focusing at infinity.

In yet another embodiment, as an optimal solution, the first lens L1, the sixth lens L6 and the thirteenth lens L13 may include all optical lenses with a refractive index higher than 1.9.

In one embodiment, the aperture of the M43 frame super wide aperture medium-short focal length lens may be between 0.9 to 1.2. The focal length range of the M43 frame super wide aperture medium-short focal length lens may be 15 mm to 35 mm.

In another embodiment, as an optimal solution, the fifth lens L5, the tenth lens L10 and the eleventh lens L11 may include all aspherical lenses.

In one example of embodiments of the invention, the relevant parameters of each lens may be shown in Table 1-1, Table 1-2 and Table 1-3 as follows:

TABLE 1-1

| Sequence | | | thickness | | Abbe |
|---|---|---|---|---|---|
| number of the | | radius R | D | refractive | number, |
| front page | Lens type | (mm) | (mm) | index Nd | Ad |
| 1 | spherical | 34.0609 | 5.7006 | 1.93 | 20.88 |
| | surface | | | | |
| 2 | spherical | 138.871 | 3.18698 | | |
| | surface | | | | |
| 3 | spherical | 202.35 | 1 | 1.59 | 68.34 |
| | surface | | | | |
| 4 | spherical | 13.863 | 6.92346 | | |
| | surface | | | | |
| 5 | spherical | −22.1991 | 1 | 1.82 | 22.70 |
| | surface | | | | |
| 6 | spherical | 19.295 | 9.07113 | 1.81 | 34.97 |
| | surface | | | | |
| 7 | spherical | −47.882 | 0.455452 | | |
| | surface | | | | |
| 8 | aspherical | 150 | 6 | 1.78 | 49.52 |
| | surface | | | | |
| 9 | aspherical | −27.8404 | 1.40864 | | |
| | surface | | | | |
| 10 | spherical | 54.3758 | 5.13804 | 2.00 | 16.48 |
| | surface | | | | |
| 11 | spherical | −72.7752 | 0.2 | | |
| | surface | | | | |
| 12 | spherical | −116.931 | 1 | 1.82 | 22.76 |
| | surface | | | | |
| 13 | spherical | 25.3272 | 5.26813 | | |
| | surface | | | | |
| 14 | spherical | Infinity | 2.72269 | | |
| | surface | | | | |
| 15 | spherical | −63.7518 | 1 | 1.86 | 25.15 |
| | surface | | | | |
| 16 | spherical | 25.8709 | 9.2212 | 1.59 | 68.62 |
| | surface | | | | |
| 17 | spherical | −33.9286 | 0.872713 | | |
| | surface | | | | |
| 18 | aspherical | 132.527 | 6.28703 | 1.78 | 49.52 |
| | surface | | | | |
| 19 | aspherical | −35.0026 | D1 | | |
| | surface | | | | |
| 20 | aspherical | 300 | 1.27697 | 1.69 | 31.18 |
| | surface | | | | |
| 21 | aspherical | 47.5105 | | | |
| | surface | | | | |
| 22 | spherical | 32.5943 | 4.75031 | 1.78 | 49.60 |
| | surface | | | | |
| 23 | spherical | −77.822 | 0.2 | | |
| | surface | | | | |
| 24 | spherical | 145.313 | 2.92252 | 1.96 | 17.94 |
| | surface | | | | |
| 25 | spherical | −45.299 | 1.50853 | 1.70 | 30.05 |
| | surface | | | | |
| 26 | spherical | 24.1718 | 11.3893 | | |
| | surface | | | | |
| 27 | spherical | Infinity | 4.2 | 1.52 | 64.20 |
| | surface | | | | |
| 28 | spherical | Infinity | 0.5 | | |
| | surface | | | | |
| 29 | spherical | Infinity | 0 | | |
| | surface | | | | |

TABLE 1-2
Example 1: aspherical coefficient

| Sequence | | | | | | |
|---|---|---|---|---|---|---|
| number of | | | | | | |
| the front | | | | | | |
| page | k | A4 | A6 | A8 | A10 | A12 |
| 8 | −10 | −3.00E−06 | 1.13E−08 | 1.41E−10 | −4.44E−13 | 0 |
| 9 | −1.38966 | 7.00E−06 | −7.54E−09 | 7.04E−11 | 1.73E−13 | −1.24E−15 |
| 18 | 10 | 1.00E−05 | −4.30E−08 | 1.62E−10 | −2.15E−13 | 0 |
| 19 | 0.44509 | 1.10E−05 | −3.47E−08 | 1.04E−10 | −8.40E−14 | −7.98E−17 |
| 20 | 0 | 9.80E−05 | −4.36E−07 | 1.38E−09 | −3.27E−12 | 4.30E−15 |
| 21 | 8.42368 | 1.01E−04 | −3.87E−07 | 8.81E−10 | −1.68E−12 | 0 |

TABLE 1-3
Example 1: focal data

| | | | |
|---|---|---|---|
| object distance | infinity | 1000 | mm |
| focal distance | 23.75 mm | 23.61 | mm |

| | | |
|---|---|---|
| D1(mm) | 1.17 | 2.54 |
| D2 (mm) | 5.62 | 4.25 |

| | |
|---|---|
| image height | 10.9 mm |
| iris diaphragm | 0.98 |

In Example 2 of the aspects of the invention, the relevant parameters of each lens may be shown in Table 2-1. Table 2-2 and Table 2-3 as follows:

TABLE 2-1

| Face | | | thickness | | Abbe |
|---|---|---|---|---|---|
| sequence | | radius R | D | refractive | number, |
| number | Lens type | (mm) | (mm) | index Nd | Vd |
| 1 | spherical | 229.606 | 2.93574 | 1.96 | 32.32 |
| | surface | | | | |
| 2 | spherical | −109.266 | 0.2 | | |
| | surface | | | | |
| 3 | spherical | −889.483 | 1.2 | 1.44 | 94.52 |
| | surface | | | | |
| 4 | spherical | 18.0221 | 7.53906 | | |
| | surface | | | | |
| 5 | spherical | −25.1521 | 1.2 | 1.69 | 26.81 |
| | surface | | | | |
| 6 | spherical | 85.6934 | 3.94882 | 1.81 | 46.57 |
| | surface | | | | |
| 7 | spherical | −105.559 | 0.2 | | |
| | surface | | | | |
| 8 | aspherical | 125.837 | 4.91273 | 1.78 | 49.52 |
| | surface | | | | |
| 9 | aspherical | −47.6304 | 0.2 | | |
| | surface | | | | |
| 10 | spherical | 33.3363 | 4.78001 | 2.01 | 19.32 |
| | surface | | | | |
| 11 | spherical | 799.514 | 0.2 | | |
| | surface | | | | |
| 12 | spherical | 526.405 | 1.2 | 1.82 | 22.76 |
| | surface | | | | |
| 13 | spherical | 35.4906 | 5.98788 | | |
| | surface | | | | |
| 14 | spherical | Infinity | 7.03004 | | |
| | surface | | | | |
| 15 | spherical | −24 | 1.2 | 1.76 | 27.53 |
| | surface | | | | |
| 16 | spherical | 34.9999 | 9.5208 | 1.55 | 75.50 |
| | surface | | | | |
| 17 | spherical | −31.7417 | 0.581531 | | |
| | surface | | | | |
| 18 | aspherical | 44.3859 | 9.55542 | 1.78 | 49.52 |
| | surface | | | | |
| 19 | aspherical | −39.1983 | D1 | | |
| | surface | | | | |
| 20 | aspherical | 600 | 1.2 | 1.69 | 31.18 |
| | surface | | | | |
| 21 | aspherical | 37.7254 | D2 | | |
| | surface | | | | |
| 22 | spherical | 46.9918 | 6.09359 | 1.59 | 68.62 |
| | surface | | | | |
| 23 | spherical | −99.4462 | 0.2 | | |
| | surface | | | | |
| 24 | spherical | 37.5489 | 6.37607 | 2.06 | 26.94 |
| | surface | | | | |
| 25 | spherical | −100 | 1.2 | 1.75 | 27.76 |
| | surface | | | | |
| 26 | spherical | 24.4524 | 11.75 | | |
| | surface | | | | |
| 27 | spherical | Infinity | 4.2 | 1.52 | 64.20 |
| | surface | | | | |
| 28 | spherical | Infinity | 0.5 | | |
| | surface | | | | |
| 29 | spherical | Infinity | 0 | | |
| | surface | | | | |

TABLE 2-2
Example 2: aspherical coefficient

| Sequence | | | | | | |
|---|---|---|---|---|---|---|
| number of | | | | | | |
| the front | | | | | | |
| page | k | A4 | A6 | A8 | A10 | A12 |
| 8 | 19.6707 | 7.00E−06 | 2.44E−09 | 1.02E−10 | −3.08E−13 | 5.21E−16 |
| 9 | −1.16826 | 6.00E−06 | 7.01E−09 | 8.07E−11 | −1.41E−13 | 2.52E−16 |
| 18 | −0.214851 | −3.00E−06 | −5.16E−09 | 6.83E−12 | −3.81E−14 | 1.13E−16 |
| 19 | −2.96098 | 2.00E−06 | −1.15E−08 | 2.36E−11 | −6.53E−14 | 1.26E−16 |
| 20 | 0 | 1.10E−05 | −5.71E−09 | −2.10E−11 | 2.57E−14 | −3.42E−17 |
| 21 | 0 | 1.20E−05 | 1.09E−08 | −5.99E−11 | 1.50E−13 | −3.71E−16 |

TABLE 2-3
Example 2: focal data

| | | | |
|---|---|---|---|
| object distance | infinity | 1000 | mm |
| focal distance | 23.75 mm | 23.67 | mm |

| | | |
|---|---|---|
| D1(mm) | 0.85 | 1.84 |
| D2 (mm) | 5.24 | 4.25 |

| | |
|---|---|
| image height | 10.9 mm |
| iris diaphragm | 0.99 |

Table 3 below shows a comparison of the data from Examples 1 and 2:

TABLE 3

| condition expression | Example 1 | Example 2 |
|---|---|---|
| f(G1)/F | 4.40 | 4.29 |
| f(G3)/F | −3.44 | −2.45 |
| f(G2)/f(G4) | 0.71 | 0.79 |
| f(G4)/f(G1-G3) | 1.14 | 0.73 |
| S3/S | 0.25 | 0.30 |

As shown in FIG. 1, in the embodiments of this invention, the eleventh lens L11 may move along the optical axis to focus between the tenth lens L10 and the twelfth lens L12. Since the eleventh lens L11 may focus internally, the overall length of the lens can be maintained constant when adjusting the focal length.

In one example, the M43 format super wide aperture medium-short focal length lens may correct all kinds of aberrations in each band, so that the central and edge field of view have enough resolution. In one embodiment, the lens may have the advantages of simple structure, small volume and large aperture, and can achieve high resolution imaging from infinity to close distance.

It should be pointed out that the ultra-large aperture medium-short focal length lens may adopt an integrated design to achieve miniaturization of the lens while obtaining excellent optical performance with high resolution, low breathing and low distortion. In some embodiments, the lens may be designed to match the camera mounts of various brands on the market according to actual use requirements, so as to realize personalized customization and general cooperation.

Clearly, the above examples are provided to illustrate the points made and are not intended to limit the scope of the implementation methods. Ordinary skilled in the art may make various changes or variations based on the above description. It is neither necessary nor possible to exhaust all possible implementations. Any obvious changes or variations that arise from these should still be within the scope of protection of embodiments of the invention.

What is claimed is:

1. An ultra-large aperture medium-short focal length lens with an M43 format comprising:
a first lens group (G1);
a second lens group (G2);
a third lens group (G3); and
a fourth lens group (G4) arranged sequentially from an object side to an image side along an optical axis; focal lengths of all lens groups satisfy:
3<f(G1)/F<5;
−4<f(G3)/F<−2;
0.5<f(G2)/f(G4)<0.9; and
0.4<f(G4)/f(G1−G3)<1.5;
wherein f(G1) represents a focal length of the first lens group (G1), f(G2) represents a focal length of the second lens group (G2), f(G3) represents a focal length of the third lens group (G3), f(G4) represents a focal length of the fourth lens group (G4), and f(G1-G3) represents a combined focal length of the first, second, and third lens groups (G1, G2, and G3); F represents a combined focal length of all lens groups;
wherein the third lens group (G3) comprises only one lens;
wherein the third lens group (G3) is configured to move along the optical axis.

2. The ultra-large aperture medium-short focal length lens with the M43 format of claim 1,
wherein the first lens group (G1) includes a first lens L1, a second lens L2, a third lens L3, a fourth lens L4, a fifth lens L5, a sixth lens L6, and a seventh lens L7, arranged sequentially from the object side to the image side along the optical axis;
wherein the first lens (L1) comprises a positive refractive power lens with a convex surface facing the object side;
wherein the second lens (L2) comprises a negative light focal power lens with the concave surface facing an image plane;
wherein the third lens (L3) comprises a double concave lens;
wherein the fourth lens (L4) comprises a double convex lens;
wherein the fifth lens (L5) comprises a double convex lens;
wherein the sixth lens (L6) comprises a positive refractive power lens with a convex surface facing the object side; and
wherein the seventh lens (L7) is a negative light focal power lens with a concave surface facing the image side.

3. The ultra-large aperture medium-short focal length lens of the M43 format of claim 1, wherein the second lens group (G2) comprises an eighth lens (L8), a ninth lens (L9) and a tenth lens (L10) arranged sequentially from the object side to the image side along the optical axis;
wherein the eighth lens (L8) comprises a double concave lens;
wherein the ninth lens (L9) comprises a positive refractive power lens with a convex surface facing the image side; and
wherein the tenth lens (L10) comprises a double convex lens.

4. The ultra-large aperture medium-short focal length lens of the M43 format of claim 1, wherein the third lens group (G3) comprises an eleventh lens (L11) and a crescent-shaped lens with a convex surface facing the object side.

5. The ultra-large aperture medium-short focal length lens of the M43 format of claim 1, wherein the fourth lens group (G4) comprises the twelfth lens (L12), the thirteenth lens (L13) and the fourteenth lens (L14) arranged sequentially from the object side to the image side along the optical axis;
wherein the twelfth lens (L12) comprises a double convex lens;
wherein the thirteenth lens (L13) comprises a double convex lens; and
wherein the fourteenth lens (L14) comprises a double concave lens.

6. The ultra-large aperture medium-short focal length lens of the M43 format of claim 1, wherein a distance between the twelfth lens (L12) and the first lens (L1) satisfies the following condition formula:
0.15<S3/S<0.4;
wherein, S3 comprises a distance from an intersection point of an optical axis of the twelfth lens (L12) to the object side to the image plane in response to an infinity focal point is achieved, and S comprises a distance from an intersection point of the object side of the first lens (L1) to the image plane in response to the infinity focal point is achieved.

7. The ultra-large aperture medium-short focal length lens of the M43 format of claim 1, wherein the first lens (L1), the sixth lens (L6) and the thirteenth lens (L13) comprise all optical lenses with a refractive index higher than 1.9.

8. The ultra-large aperture medium-short focal length lens of the M43 format of claim 1, wherein the ultra-large aperture comprises 0.9 to 1.2.

9. The ultra-large aperture medium-short focal length lens of the M43 format of claim 1, wherein a focal length range of the ultra-large aperture medium-short focal length lens of the M43 format comprises 15 mm-35 mm.

10. The ultra-large aperture medium-short focal length lens of the M43 format of claim 5, wherein the fifth lens (L5), the tenth lens (L10) and the eleventh lens (L11) comprise all aspherical lenses.
